(19) United States
(12) Patent Application Publication
(10) Pub. No.: US 2016/0365059 A1
(43) Pub. Date: Dec. 15, 2016

(54) DISPLAY DEVICE AND A METHOD FOR DRIVING THE SAME

(71) Applicant: SAMSUNG DISPLAY CO., LTD., Yongin-Si (KR)

(72) Inventors: MIN-SOO CHOI, Asan-si (KR); YOUNG-IL BAN, Hwaseong-si (KR); Sunkyu Son, Suwon-si (KR); Junpyo Lee, Asan-si (KR); Seunghwan Moon, Asan-si (KR)

(21) Appl. No.: 15/066,502

(22) Filed: Mar. 10, 2016

(30) Foreign Application Priority Data
Jun. 15, 2015 (KR) 10-2015-0084245

(51) Int. Cl. G09G 3/36

(52) U.S. Cl. CPC G09G 3/3696; G09G 3/3607; G09G 3/3614; G09G 2300/0452; G09G 2310/08; G09G 2320/0209; G09G 2320/0247; G09G 2370/04; G09G 2370/08

(57) ABSTRACT

A display device includes a signal controller. A data driver is connected to the signal controller. A memory unit is connected to the signal controller. The memory unit stores data driver characteristic information corresponding to a manufacturer identification (ID) of each of a plurality of data drivers. The data driver transmits a manufacturer ID to the signal controller. The signal controller reads, from the memory unit, data driver characteristic information corresponding to the manufacturer ID received from the data driver, and the signal controller generates image data and a control signal based on the read data driver characteristic information.

### CROSS-REFERENCE TO RELATED APPLICATION

This U.S. non-provisional patent application claims priority under 35 U.S.C. §119 to Korean Patent Application No. 10-2015-0084245, filed on Jun. 15, 2015, in the Korean Intellectual Property Office, the disclosure of which is incorporated by reference herein in its entirety.

### TECHNICAL FIELD

The present inventive concept relates to a display device and a method for driving the same.

### DISCUSSION OF THE RELATED ART

In general, a display device includes a display panel having data lines and gate lines, a data driver configured to provide a data signal to the data lines, a gate driver configured to provide a gate signal to the gate lines, and a signal controller configured to control the data driver and the gate driver.

The signal controller and the data driver are connected to each other via a two-way communication interface that permits transmission and reception of data bidirectionally.

Data drivers are produced by a variety of manufacturers. Furthermore, the same manufacturer may produce a variety of different display drivers. Accordingly, data drivers may have different characteristics from each other.

When this is the case, since a signal controller tends to always generate the same image data or control signal, defects such as crosstalk or flicker may occur.

### SUMMARY

According to an exemplary embodiment of the inventive concept, a display device includes a signal controller. A data driver is connected to the signal controller. A memory unit is connected to the signal controller. The memory unit stores data driver characteristic information corresponding to a manufacturer identification (ID) of each of a plurality of data drivers. The data driver transmits a manufacturer ID to the signal controller. The signal controller reads, from the memory unit, data driver characteristic information corresponding to the manufacturer ID received from the data driver, and the signal controller generates image data and a control signal based on the read data driver characteristic information.

In an exemplary embodiment of the inventive concept, the data driver characteristic information comprises a gamma-value, a common voltage, or chromaticity information.

In an exemplary embodiment of the inventive concept, the signal controller and the data driver are connected through a first interface, the signal controller and the memory unit are connected through a second interface, and the first and second interfaces are two-way communication interfaces.

In an exemplary embodiment of the inventive concept, the data driver is an integrated circuit comprising a plurality of terminals for transmitting the manufacturer ID of the data driver.

In an exemplary embodiment of the inventive concept, the plurality of terminals for transmitting the manufacturer ID comprises n physical pins, and a high level voltage value or a low level voltage value is applied to each of the n physical pins.

In an exemplary embodiment of the inventive concept, data driver characteristic information for 2ⁿ manufacturers are stored in the memory unit.

In an exemplary embodiment of the inventive concept, a bidirectional signal that the signal controller and the data driver mutually transmit and receive via the first interface comprises a first signal and a second signal. The first signal is transmitted from the signal controller to the data driver and the second signal is transmitted from the data driver to the signal controller at a different timing from that of the first signal.

In an exemplary embodiment of the inventive concept, the first signal comprises the image data and the control signal, and the second signal comprises the manufacturer ID of the data driver.

In an exemplary embodiment of the inventive concept, the signal controller monitors the second signal to identify the manufacturer ID of the data driver.

According to an exemplary embodiment of the inventive concept, a method for driving a display device includes a signal controller, a data driver connected to the signal controller, and a memory unit connected to the signal controller, wherein the memory unit stores data driver characteristic information corresponding to a manufacturer identification (ID) of a plurality of data drivers. The method includes transmitting a manufacturer ID of the data driver from the data driver to the signal controller, reading from the memory unit data driver characteristic information corresponding to the manufacturer ID received from the data driver, and generating image data and a control signal based on the read data driver characteristic information using the signal controller.

In an exemplary embodiment of the inventive concept, the data driver characteristic information comprises a gamma-value, a common voltage, or chromaticity information.

In an exemplary embodiment of the inventive concept, the data driver is an integrated circuit comprising a plurality of terminals for transmitting the manufacturer ID of the data driver.

In an exemplary embodiment of the inventive concept, the plurality of terminals for transmitting the manufacturer ID of the data driver comprise n physical pins, and either a high level voltage value or a low level voltage value is applied to each of the n physical pins.

In an exemplary embodiment of the inventive concept, data driver characteristic information for 2ⁿ manufacturers are stored in different addresses of the memory unit.

In an exemplary embodiment of the inventive concept, reading from the memory unit data driver characteristic information corresponding to the manufacturer ID received from the data driver includes transmitting, from the signal controller, a command signal to the memory unit to read an address of the memory unit corresponding to the manufacturer ID of the data driver, and transmitting, from the memory unit to the signal controller, the data driver characteristic information stored in the address of the memory unit corresponding to the manufacturer ID of the data driver based on the command signal.

In an exemplary embodiment of the inventive concept, generating the image data and the control signal based on the read data driver characteristic information occurs after transmitting the manufacturer ID of the data driver from the data driver to the signal controller.

According to an exemplary embodiment of the inventive concept, a display device includes a memory unit storing data driver characteristic information for a plurality of data drivers. A signal controller is connected to the first memory unit through a first interface. A first data driver is connected to the signal controller through a second interface. The first and second interfaces are two-way communication interfaces.

In an exemplary embodiment of the inventive concept, when the first data driver transmits a first identification (ID) to the signal controller through the second interface, the signal controller obtains data driver characteristic information corresponding to the first ID from the memory unit through the first interface, and provides image data and a control signal corresponding to the first ID to the first data driver through the second interface.

In an exemplary embodiment of the inventive concept, the display device further includes a second data driver connected to the signal controller through the second interface. When the second data driver transmits a second ID to the signal controller through the second interface, the signal controller obtains data driver characteristic information corresponding to the second ID from the memory unit through the first interface, and provides image data and a control signal corresponding to the second ID to the second data driver through the second interface. The first ID is different from the second ID.

### BRIEF DESCRIPTION OF THE DRAWINGS

The above and other features of the inventive concept will be more clearly understood by describing in detail exemplary embodiments thereof with reference to the accompanying drawings, in which:

FIG. 1 is a block diagram of a display device according to an exemplary embodiment of the inventive concept;

FIG. 2 is a block diagram illustrating a data driver of the display device illustrated in FIG. 1, according to an exemplary embodiment of the inventive concept;

FIG. 3 is a block diagram illustrating a memory unit of the display device illustrated in FIG. 1, according to an exemplary embodiment of the inventive concept;

FIG. 4 is a block diagram illustrating a signal controller and a memory unit of the display device illustrated in FIG. 1, according to an exemplary embodiment of the inventive concept;

FIG. 5A illustrates a data driver according to an exemplary embodiment of the inventive concept;

FIG. 5B illustrates a data driver according to an exemplary embodiment of the inventive concept;

FIG. 5C illustrates a data driver according to an exemplary embodiment of the inventive concept;

FIG. 5D illustrates a data driver according to an exemplary embodiment of the inventive concept;

FIG. 6 illustrates bidirectional signals transmitted and received between a signal controller and a data driver, according to an exemplary embodiment of the inventive concept;

FIG. 7 illustrates bidirectional signals transmitted and received between a signal controller and a data driver, according to an exemplary embodiment of the inventive concept;

FIG. 8 illustrates a flowchart of a method for driving a display device, according to an exemplary embodiment of the inventive concept; and

FIG. 9 illustrates a flowchart of a method for driving a display device, according to an exemplary embodiment of the inventive concept.

### DETAILED DESCRIPTION OF THE EMBODIMENTS

Exemplary embodiments of the inventive concept will now be described more fully hereinafter with reference to the accompanying drawings. The inventive concept may, however, be embodied in different forms and should not be construed as being limited to the exemplary embodiments disclosed herein.

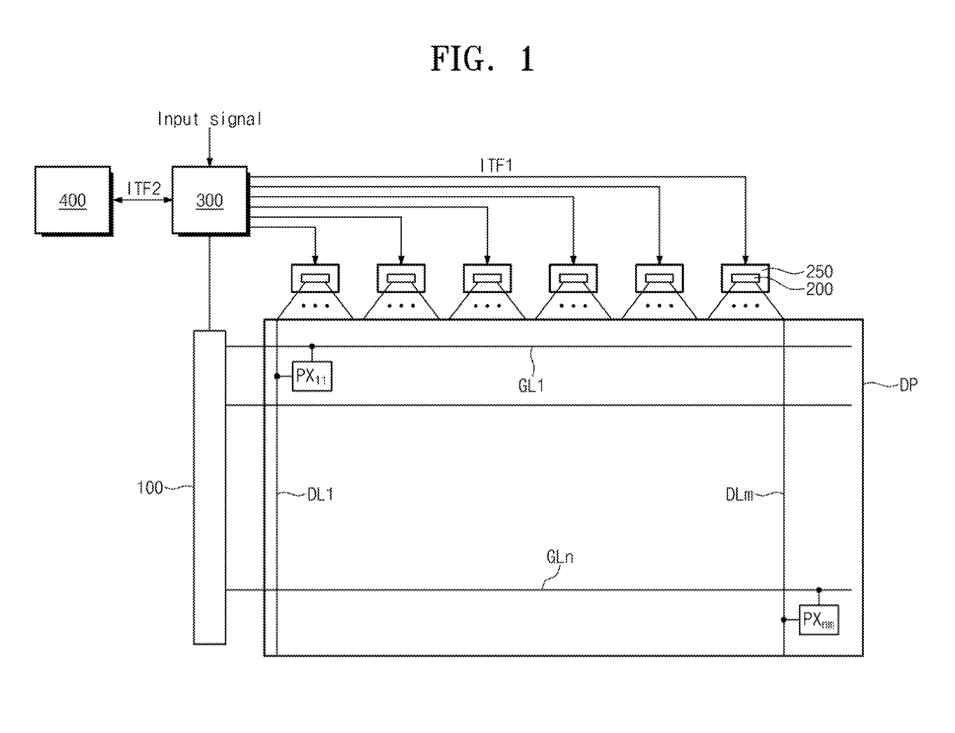

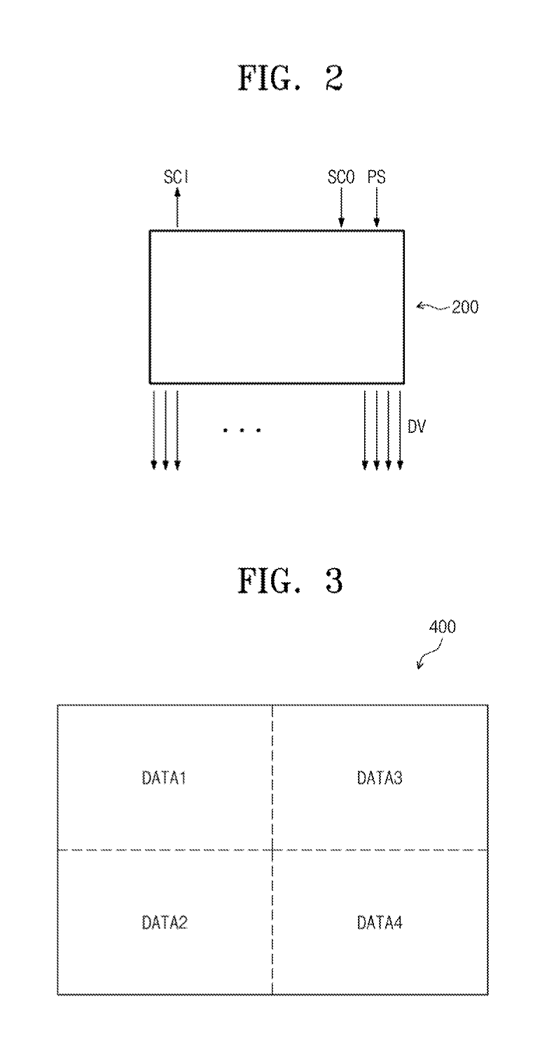

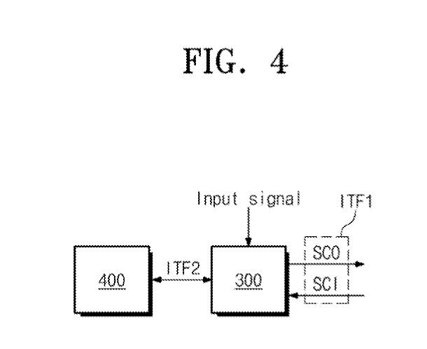

FIG. 1 is a block diagram of a display device according to an exemplary embodiment of the inventive concept. FIG. 2 is a block diagram illustrating a data driver of the display device illustrated in FIG. 1, according to an exemplary embodiment of the inventive concept. FIG. 3 is a block diagram illustrating a memory unit of the display device illustrated in FIG. 1, according to an exemplary embodiment of the inventive concept. FIG. 4 is a block diagram illustrating a signal controller and a memory unit of the display device in FIG. 1, according to an exemplary embodiment of the inventive concept.

As illustrated in FIG. 1, a display device, according to an exemplary embodiment of the inventive concept, includes a display panel DP, a gate driver 100, a plurality of data drivers 200, a signal controller 300 (e.g., a timing controller), and a memory unit 400.

Examples of the display panel DP may include, but are not limited to, a variety of display panels such as a liquid crystal display panel, an organic light emitting display panel, an electrophoretic display panel, and an electrowetting display panel.

In a plan view, the display panel DP includes a display area in which a plurality of pixels PX₁₁ to PXₙₘ are disposed and a non-display area surrounding the display area.

The display panel DP includes a plurality of gate lines GL1 to GLn and a plurality of data lines DL1 to DLm intersecting the gate lines GL1 to GLn. The plurality of gate lines GL1 to GLn are connected to the gate driver 100. The plurality of data lines DL1 to DLm are connected to the data drivers 200. In FIG. 1, only some of the plurality of gate lines GL1 to GLn and some of the plurality of data lines DL1 to DLm are illustrated for clarity.

In FIG. 1, only some of the plurality of pixels PX₁₁ to PXₙₘ are illustrated for clarity. The plurality of pixels PX₁₁ to PXₙₘ are respectively connected to corresponding gate lines, from among the plurality of gate lines GL1 to GLn, and corresponding data lines, from among the plurality of data lines DL1 to DLm.

The plurality of pixels PX₁₁ to PXₙₘ may be divided into a plurality of groups according to colors displayed by the pixels. Each pixel, from among the plurality of pixels PX₁₁ to PXₙₘ, may display a primary color. The primary colors may include red, green, blue, and white. Alternatively, the primary colors may include various colors such as yellow, cyan, and magenta.

The gate driver 100 and the data drivers 200 are controlled by the signal controller 300. The signal controller 300 may be mounted on a main circuit board. The signal controller 300 receives, from an external graphic controller, an input signal related to an image. The signal controller 300 outputs control signals for controlling the data drivers 200, and the like. The control signals may include a vertical synchronizing signal for distinguishing frame sections, a signal for distinguishing horizontal sections (e.g., a horizontal synchronizing signal for distinguishing rows), a data enable signal having a high level only during data output sections to indicate data input areas, and a clock signal.

The gate driver 100 generates gate signals on the basis of a control signal received from the signal controller 300 during the frame sections, and outputs the gate signals to the plurality of gate lines GL1 to GLn. The gate signals may be sequentially output. The gate driver 100 may be formed simultaneously with the pixels PX₁₁ to PXₙₘ through a thin film process. For example, the gate driver 100 may be mounted on the non-display area of the display panel in the form of an amorphous silicon thin film transistor (TFT) gate driver circuit (ASG) or an oxide semiconductor TFT gate driver circuit (OSG).

Referring to FIGS. 1 and 2, each of the data drivers 200 outputs a signal control input SCI and receives a signal control output SCO. Also, each of the data drivers 200 receives a power source PS for its own operation. Each of the data drivers 200 outputs data voltages DV. Hereinafter, a description of the data drivers 200 will be provided in detail.

The data drivers 200 are connected to the signal controller 300 via a first interface ITF1. In this case, the first interface ITF1 allows for two-way communication between the data drivers 200 and the signal controller 300.

The first interface ITF1 may include the signal control output SCO and the signal control input SCI. The signal control output SCO is a signal or data which is output from the signal controller 300 and is input to the data drivers 200. The signal control input SCI is a signal or data which is output from the data drivers 200 and is input to the signal controller 300. The signal control output SCO may include image data and a control signal which are generated from the signal controller 300. The signal control input SCI may include information by which the status of each data driver 200, from among the plurality of data drivers 200, may be checked, and a manufacturer identification (ID) of each of the data drivers 200.

The data drivers 200 generate data voltages DV according to image data provided from the signal controller 300 on the basis of a control signal, hereinafter referred to as a data control signal, received from the signal controller 300. The data drivers 200 output the data voltages DV to corresponding data lines, from among the plurality of data lines DL1 to DLm.

The data voltages DV may include positive data voltages having positive values with respect to a common voltage and/or negative data voltages having negative values with respect to the common voltage. During each of the horizontal sections, some of the data voltages DV applied to the data lines DL1 to DLm may have a positive polarity, and some of the data voltages DV may have a negative polarity. In the case of a liquid crystal display device, the polarity of the data voltages DV may be inverted according to the frame section to prevent the degradation of liquid crystal. The data drivers 200 may generate data voltages DV inverted in frame section units in response to an inversion signal.

Each data driver 200 may be mounted on a corresponding flexible circuit board 250. The plurality of data drivers 200 provide the data lines DL1 to DLm with corresponding data signals.

When assembling display devices, display device manufacturers may use data drivers 200 obtained from many different companies instead of data drivers 200 obtained from only one manufacturer. In such a case, characteristics, for example, chromaticity information, gamma-values, common voltage levels, and the like may be different depending on the manufacturers of the data drivers 200. If these differences are not addressed, defects such as crosstalk or flicker may occur.

According to an exemplary embodiment of the inventive concept, each of the data drivers 200 transmits its manufacturer ID to the signal controller 300. The manufacturer ID includes information about the device's manufacturer. The signal control input SCI provided from the data driver 200 to the signal controller 300 includes the manufacturer ID.

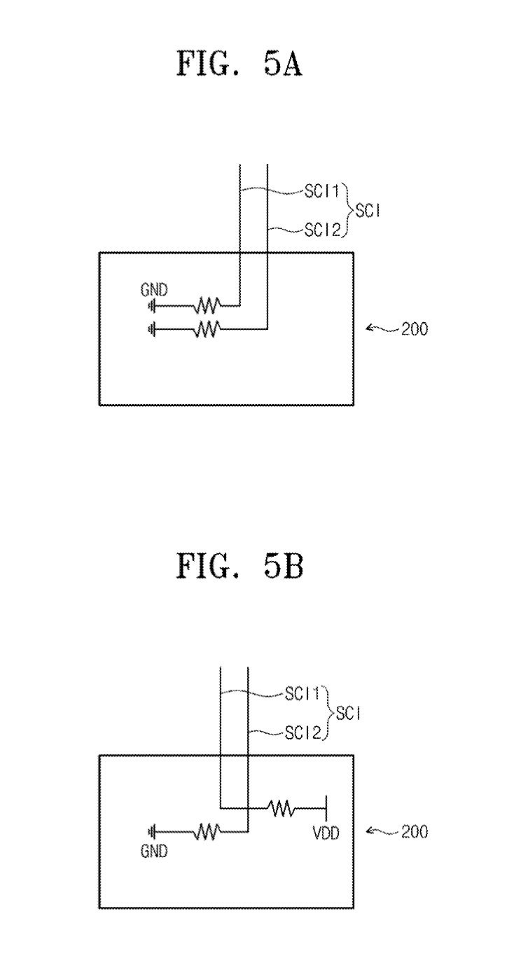

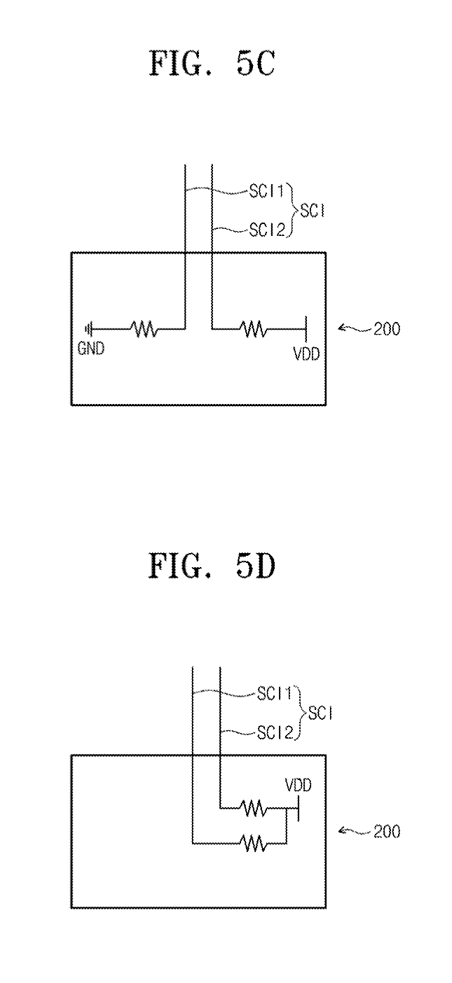

A method for transmitting a manufacturer ID from a data driver 200 to the signal controller 300 will be described in detail with reference to FIGS. 5A to 7.

Referring to FIGS. 1 and 3, the memory unit 400 is connected to the signal controller 300 through a second interface ITF2. In this case, the second interface ITF2 allows for two-way communication between the memory unit 400 and the signal controller 300. The memory unit 400 is a memory in which data may be stored. The memory unit 400 stores a plurality of pieces of data driver characteristic information corresponding to the manufacturer ID of each of the data drivers 200. The plurality of pieces of data driver characteristic information may include chromaticity information, gamma-values, common voltage levels, and the like, corresponding to a particular manufacturer's drivers.

The memory unit 400 may be an electrically erasable programmable read-only memory (EEPROM). The EEPROM is a non-volatile memory which maintains stored data even when not powered. The EEPROM allows for erasing and writing of stored data. It is possible to erase or write data by electrically changing the charge of an element constituting the EEPROM.

Referring to FIGS. 1 and 4, the signal controller 300 receives a manufacturer ID from a data driver 200, from among the plurality of data drivers 200. The manufacturer ID is included in the signal control input SCI.

The signal controller 300 reads, from the memory unit 400, characteristic information about the data driver 200 corresponding to the manufacturer ID received from the data driver 200. The signal controller 300 generates image data from an input signal on the basis of the read data driver characteristic information. Also, the signal controller 300 may generate a data control signal on the basis of the read data driver characteristic information. In other words, the signal data and data control signal are generated in consideration of the characteristics associated with the received manufacturer ID.

The signal controller 300 may transmit a read command to the memory unit 400 through the second interface ITF2. The memory unit 400 may transmit characteristic information of the data driver 200 to the signal controller 300 through the second interface ITF2, in response to the read command.

FIGS. 5A to 5D illustrate data drivers according to exemplary embodiments of the inventive concept.

Referring to FIGS. 5A to 5D, each of the data drivers 200 is an integrated circuit including a plurality of terminals, and at least one of the plurality of terminals of each data driver 200 is a terminal for transmitting a manufacturer ID.

The terminal for transmitting a manufacturer ID may include n physical pins (e.g., n is a positive integer). Either a high level voltage value VDD or a low level voltage value GND may be applied to each of the n physical pins. Characteristic information on data drivers 200 for 2ⁿ manufacturers may be expressed using the n physical pins. Accordingly, when the number of the physical pins is n, pieces of data driver characteristic information for 2ⁿ manufacturers may be stored in the memory unit 400 (see FIG. 3).

FIGS. 5A to 5D illustrate examples in the case where n=2. When n=2, 2²=4 manufacturer IDs may be implemented. Accordingly, FIG. 3 also illustrates four pieces of data driver characteristic information DATA1 to DATA4 as an example. However, the inventive concept is not limited thereto and when each of the data drivers 200 has 3 physical pins (e.g., n=3, therefore 2³=8), pieces of data driver characteristic information for 8 manufacturers of data drivers 200 may be stored in the memory unit 400.

Referring to FIG. 5A, n is assumed to equal 2, and the signal control input SCI thus includes first and second signal control inputs SCI1 and SCI2. The first and second signal control inputs SCI1 and SCI2 may respectively correspond to physical pins of the data driver 200 illustrated in FIG. 5A.

The low level voltage value GND is applied to both the first and second signal control inputs SCI1 and SCI2. When the low level voltage value GND equals 0 and the high level voltage value VDD equals 1, the first and second signal control inputs SCI1 and SCI2 may be expressed as 00₂ as a binary number.

Therefore, the data driver 200 illustrated in FIG. 5A transmits the manufacturer ID of a first manufacturer to the signal controller 300 (see FIG. 1) through the 00₂ data created by using two low level voltage values GND.

Referring to FIG. 5B, n is assumed to equal 2, and the signal control input SCI thus includes first and second signal control inputs SCI1 and SCI2. The first and second signal control inputs SCI1 and SCI2 may respectively correspond to physical pins of the data driver 200 illustrated in FIG. 5B.

The high level voltage value VDD is applied to the first signal control input SCI1, and the low level voltage value GND is applied to the second signal control input SCI2. When the low level voltage value GND equals 0 and the high level voltage value VDD equals 1, the first and second signal control inputs SCI1 and SCI2 may be expressed as 01₂ as a binary number.

Therefore, the data driver 200 illustrated in FIG. 5B transmits the manufacturer ID of a second manufacturer to the signal controller 300 (see FIG. 1) through the 01₂ data created by using the high level voltage value VDD and the low level voltage value GND.

Referring to FIG. 5C, n is assumed to equal 2, and the signal control input SCI thus includes first and second signal control inputs SCI1 and SCI2. The first and second signal control inputs SCI1 and SCI2 may respectively correspond to physical pins of the data driver 200 illustrated in FIG. 5C.

The low level voltage value GND is applied to the first signal control input SCI1, and the high level voltage value VDD is applied to the second signal control input SCI2. When the low level voltage value GND equals 0 and the high level voltage value VDD equals 1, the first and second signal control inputs SCI1 and SCI2 may be expressed as 10₂ as a binary number.

Therefore, the data driver 200 illustrated in FIG. 5C transmits the manufacturer ID of a third manufacturer to the signal controller 300 (see FIG. 1) through the 10₂ data created by using the high level voltage value VDD and the low level voltage value GND.

Referring to FIG. 5D, n is assumed to equal 2, and the signal control input SCI thus includes first and second signal control inputs SCI1 and SCI2.

The high level voltage value VDD is applied to both the first and second signal control inputs SCI1 and SCI2. When the high level voltage value VDD equals 1, the first and second signal control inputs SCI1 and SCI2 may be expressed as 11₂ as a binary number.

Therefore, the data driver 200 illustrated in FIG. 5D transmits the manufacturer ID of a fourth manufacturer to the signal controller 300 (see FIG. 1) through the 11₂ data created by using two high level voltage values VDDs.

Thus, when two physical pins for transmitting manufacturer IDs are assigned to the data drivers 200, the manufacturer IDs of first to fourth manufacturers may be transmitted. In other words, the first to fourth manufacturers may be identified by 00, 01, 10 and 11, respectively.

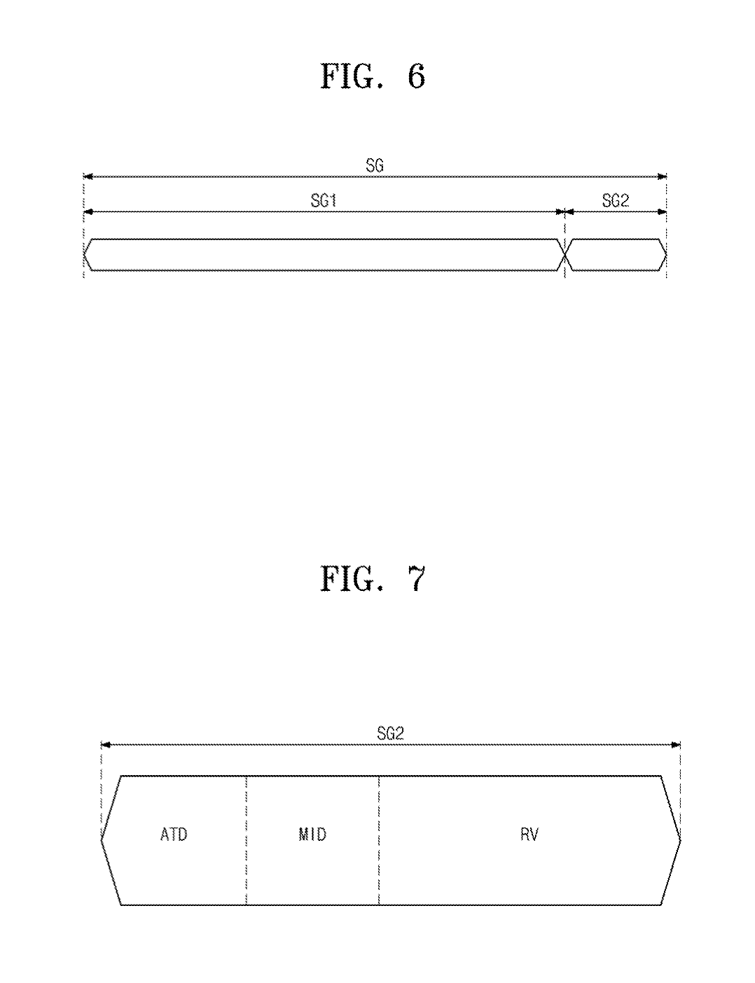

FIG. 6 illustrates bidirectional signals transmitted and received between a signal controller and a data driver, according to an exemplary embodiment of the inventive concept. FIG. 7 illustrates bidirectional signals transmitted and received between a signal controller and a data driver, according to an exemplary embodiment of the inventive concept.

Referring to FIG. 6, a bidirectional signal SG transmitted and received between the signal controller 300 and one of the data drivers 200 includes first and second signals SG1 and SG2. The first signal SG1 is a signal transmitted from the signal controller 300 (see FIG. 1) to the one of the data drivers 200 (see FIG. 1).

The first signal SG1 is a signal which is transmitted through the first interface ITF1 (see FIG. 4) and corresponds to the signal control output SCO. Therefore, the first signal SG1 may include image data and a control signal which are generated from the signal controller 300 (see FIG. 4).

The second signal SG2 is a signal which is transmitted through the first interface ITF1 (see FIG. 4) and corresponds to the signal control input SCI. Therefore, the second signal SG2 may include the manufacturer ID of the data driver 200 (see FIG. 1).

The first and second signals SG1 and SG2 are different from each other in terms of activation time. Therefore, the signal controller 300 (see FIG. 4) may identify a time when the second signal SG2 is activated, (e.g., sections in which the second signal SG2 is generated), to read the manufacturer ID in the second signal SG2.

Referring to FIG. 7, the second signal SG2 may include data driver status information ATD, a manufacturer ID MID, and reservation information RV.

The data driver status information ATD is used by the signal controller 300 to check for proper operation of the data driver 200 (see FIG. 1). The manufacturer ID MID is for identifying the manufacturer of the one of the data drivers 200 (see FIG. 1) as described above. The reservation information RV is information that may be assigned and used if necessary.

For example, when the second signal SG2 is a total of 768 bits, the data driver status information ATD, the manufacturer ID MID, and the reservation information RV may be 64 bits, 4 bits, and 700 bits, respectively. When 4 bits are assigned to the manufacturer ID MID, the assigning may be done, for example, as follows.

TABLE 1

| Manufacturer ID Bit | Item |
|---|---|
| 0XXX | Domestic manufacturer |
| 10XX | Japanese manufacturer |
| 11XX | Chinese manufacturer |

As shown in Table 1, when 0 is assigned as the first bit in 4 bits of the manufacturer ID MID, the 0 may refer to a domestic manufacturer. In this case, information on 8 domestic manufacturers may be indicated by using the remaining 3 bits.

When 1 and 0 are respectively assigned as the first bit and second bit in 4 bits of the manufacturer ID MID, the 1 and 0 may refer to a Japanese manufacturer. In this case, information on 4 Japanese manufacturers may be indicated by using the remaining 2 bits.

When 1 is assigned as the first bit and second bit in 4 bits of the manufacturer ID MID, the 1 and 1 may be defined to refer to a Chinese manufacturer. In this case, information on 4 Chinese manufacturers may be indicated by using the remaining 2 bits (e.g., 2 to the power of 2 remaining bits, which equals 4).

TABLE 2

| Manufacturer ID Bit | Item |
|---|---|
| 0000 | Domestic company A |
| 0001 | Domestic company B |
| 0010 | Domestic company C |
| 1000 | Japanese company D |
| 1100 | Chinese company E |

An example of manufacturer ID bits according to Table 1 and the corresponding manufacturer ID associated with each respective manufacturer ID bit may be as shown in Table 2. It is to be understood that Tables 1 and 2 are merely exemplary.

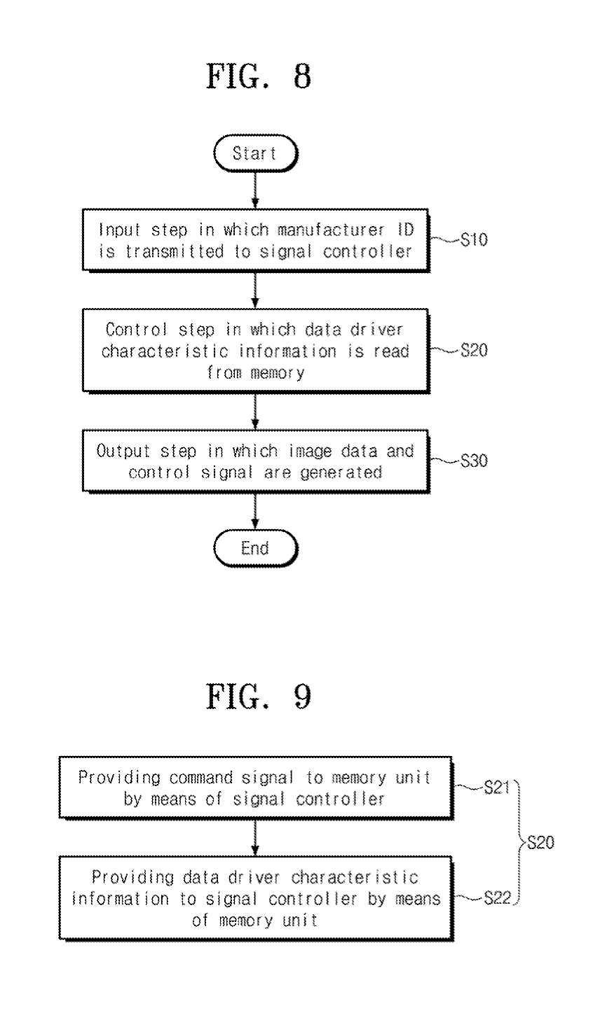

FIG. 8 illustrates a flowchart of a method for driving a display device, according to an exemplary embodiment of the inventive concept. FIG. 9 illustrates a flowchart of a method for driving a display device, according to an exemplary embodiment of the inventive concept.

Referring to FIG. 1, a display device, according to an exemplary embodiment of the inventive concept, includes the signal controller 300, the plurality of data drivers 200, and the memory unit 400. The data drivers 200 are connected to the signal controller 300. The memory unit 400 is connected to the signal controller 300 and stores a plurality of pieces of data driver characteristic information corresponding to manufacturer IDs of the data drivers 200. Pieces of data driver characteristic information corresponding to 2ⁿ manufacturers are stored in different addresses of the memory unit 400.

Referring to FIGS. 1 and 8, a method for driving the display device includes an input step S10, a control step S20, and an output step S30.

The input step S10 is a step in which the data driver 200 transmits a manufacturer ID to the signal controller 300.

The control step S20 is a step in which the signal controller 300 reads, from the memory unit 400, characteristic information on the data driver 200 corresponding to the manufacturer ID received from the data driver 200.

The output step S30 is a step in which the signal controller 300 generates image data and a control signal on the basis of the read data driver characteristic information. According to an exemplary embodiment of the inventive concept, the input step S10 occurs at a different time from the output step S30. For example, the output step S30 occurs after the input step S10.

Referring to FIG. 9, the control step S20 in FIG. 8 includes two steps. The control step S20 includes a command signal providing step S21 and a data driver characteristic information providing step S22.

The command signal providing step S21 is a step in which the signal controller 300 (see FIG. 1) provides a command signal to the memory unit 400 (see FIG. 1) to read an address corresponding to the manufacturer ID received from the one of the data drivers 200 (see FIG. 1), from among a plurality of addresses of the memory unit 400.

The data driver characteristic information providing step S22 is a step in which the memory unit 400 (see FIG. 1) provides the data driver characteristic information stored in the address to the signal controller 300 (see FIG. 1) according to the command signal already noted in FIG. 8. According to an exemplary embodiment of the inventive concept, generating (e.g., providing) the image data and the control signal based on the read data driver characteristic information occurs after transmitting the manufacturer ID of the data driver 200 from the data driver 200 to the signal controller 300.

Thus, through the display device or the method for driving a display device described with reference to FIGS. 1 to 9, it is possible to prevent defects such as crosstalk or flicker which may occur when data drivers are produced by different manufacturers or are of different types of the same manufacturer. For example, the display device includes a signal controller that generates image data and a control signal optimized for various manufacturers of data drivers. Accordingly, display quality of the display device, according to an exemplary embodiment of the inventive concept, may be increased.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A display device comprising:
a signal controller;
a data driver connected to the signal controller; and
a memory unit connected to the signal controller, wherein the memory unit stores data driver characteristic information corresponding to a manufacturer identification (ID) of each of a plurality of data drivers,
wherein the data driver transmits a manufacturer ID to the signal controller, and
the signal controller reads, from the memory unit, data driver characteristic information corresponding to the manufacturer ID received from the data driver, and the signal controller generates image data and a control signal based on the read data driver characteristic information.

2. The display device of claim 1, wherein the data driver characteristic information comprises a gamma-value, a common voltage, or chromaticity information.

3. The display device of claim 2, wherein the signal controller and the data driver are connected through a first interface,
the signal controller and the memory unit are connected through a second interface, and
the first and second interfaces are two-way communication interfaces.

4. The display device of claim 3, wherein the data driver is an integrated circuit comprising a plurality of terminals for transmitting the manufacturer ID of the data driver.

5. The display device of claim 4, wherein
the plurality of terminals for transmitting the manufacturer ID comprises n physical pins, and
a high level voltage value or a low level voltage value is applied to each of the n physical pins.

6. The display device of claim 5, wherein data driver characteristic information for 2ⁿ manufacturers are stored in the memory unit.

7. The display device of claim 3, wherein
a bidirectional signal that the signal controller and the data driver mutually transmit and receive via the first interface comprises:
a first signal transmitted from the signal controller to the data driver; and
a second signal transmitted from the data driver to the signal controller at a different timing from that of the first signal.

8. The display device of claim 7, wherein
the first signal comprises the image data and the control signal, and
the second signal comprises the manufacturer ID of the data driver.

9. The display device of claim 8, wherein the signal controller monitors the second signal to identify the manufacturer ID of the data driver.

10. A method for driving a display device including a signal controller, a data driver connected to the signal controller, and a memory unit connected to the signal controller, wherein the memory unit stores data driver characteristic information corresponding to a manufacturer identification (ID) of a plurality of data drivers, the method comprising:
transmitting a manufacturer ID of the data driver from the data driver to the signal controller;
reading from the memory unit data driver characteristic information corresponding to the manufacturer ID received from the data driver; and
generating image data and a control signal based on the read data driver characteristic information using the signal controller.

11. The method of claim 10, wherein the data driver characteristic information comprises a gamma-value, a common voltage, or chromaticity information.

12. The method of claim 11, wherein the data driver is an integrated circuit comprising a plurality of terminals for transmitting the manufacturer ID of the data driver.

13. The method of claim 12, wherein
the plurality of terminals for transmitting the manufacturer ID of the data driver comprise n physical pins, and
either a high level voltage value or a low level voltage value is applied to each of the n physical pins.

14. The method of claim 13, wherein data driver characteristic information for 2ⁿ manufacturers are stored in different addresses of the memory unit.

15. The method of claim 14, wherein reading from the memory unit data driver characteristic information corresponding to the manufacturer ID received from the data driver comprises:
transmitting, from the signal controller, a command signal to the memory unit to read an address of the memory unit corresponding to the manufacturer ID of the data driver; and
transmitting, from the memory unit to the signal controller, the data driver characteristic information stored in the address of the memory unit corresponding to the manufacturer ID of the data driver based on the command signal.

16. The method of claim 11, wherein generating the image data and the control signal based on the read data driver characteristic information occurs after transmitting the manufacturer ID of the data driver from the data driver to the signal controller.

17. A display device comprising:
a memory unit storing data driver characteristic information for a plurality of data drivers;
a signal controller connected to the first memory unit through a first interface; and
a first data driver connected to the signal controller through a second interface, wherein the first and second interfaces are two-way communication interfaces.

18. The display device of claim 17, wherein when the first data driver transmits a first identification (ID) to the signal controller through the second interface, the signal controller obtains data driver characteristic information corresponding to the first ID from the memory unit through the first interface, and provides image data and a control signal corresponding to the first ID to the first data driver through the second interface.

19. The display device of claim 18, further comprising a second data driver connected to the signal controller through the second interface,
wherein when the second data driver transmits a second ID to the signal controller through the second interface, the signal controller obtains data driver characteristic information corresponding to the second ID from the memory unit through the first interface, and provides image data and a control signal corresponding to the second ID to the second data driver through the second interface,
wherein the first ID is different from the second ID.
